(19) United States
(12) Patent Application Publication
(10) Pub. No.: US 2025/0290947 A1
(43) Pub. Date: Sep. 18, 2025

(54) METHOD AND DEVICE FOR MONITORING THE STATE OF A MICROMECHANICAL SENSOR

(71) Applicant: Robert Bosch GmbH, Stuttgart (DE)

(72) Inventors: Divya Thakurani, Stuttgart (DE); Hartmut Ruf, Koeln (DE); Alexander Sorger, Dresden (DE); Lukas Grinewitschus, Reutlingen (DE); Stefan Kiesel, Reutlingen (DE)

(21) Appl. No.: 19/072,249

(22) Filed: Mar. 6, 2025

(30) Foreign Application Priority Data
Mar. 14, 2024 (DE) 10 2024 202 405.8

(51) Int. Cl. G01P 21/00; G01C 19/5776; G01C 25/00

(52) U.S. Cl. CPC G01P 21/00; G01C 19/5776; G01C 25/00

(57) ABSTRACT

A method and a device for monitoring the state of a micromechanical sensor comprising a spring-mounted seismic mass, which is provided for converting a physical input variable into an electrical sensor output signal of the micromechanical sensor. The method includes: evaluating the sensor output signal of the micromechanical sensor for detecting harmful vibrations, which distort a recalibration of the micromechanical sensor; and interrupting the recalibration of the micromechanical sensor as soon as a harmful vibration has been detected.

### CROSS REFERENCE

The present application claims the benefit under 35 U.S.C. § 119 of German Patent Application No. DE 10 2024 202 405.8 filed Mar. 14, 2024, which is expressly incorporated herein by reference in its entirety.

### FIELD

The present invention relates to a method and a device for monitoring the state of a micromechanical sensor and in particular to a vibration recognition method for verifying the rest position of micromechanical sensors for their correct calibration.

### BACKGROUND INFORMATION

MEMS (microelectromechanical systems) are small sensors that are usually made of silicon, such as, e.g., acceleration sensors or gyroscopes. They are used for various applications in automotive or consumer electronics. There are various influences that can contribute to deterioration of the sensor signal error after soldering and during the operating life of the micromechanical sensor. Various conventional methods are available for compensating for these influences.

Vibrations as error sources in sensors or gyroscopes are discussed in U.S. Pat. Nos. 6,498,996 B1 and 11,333,499 B2. In both documents, it is described that vibrations cause an offset or a distortion. Vibrations can be characterized in terms of vibration amplitude and vibration frequency during factory calibration. The derived calibration coefficients are subsequently used to compensate for the deviation caused by vibrations.

In U.S. Pat. No. 11,333,499 B2, compensation test masses that are used to compensate for the distortion caused by vibrations are described.

### SUMMARY

According to a first aspect, the present invention provides a method for monitoring the state of a micromechanical sensor.

The present invention provides a method for monitoring the state of a micromechanical sensor comprising a spring-mounted seismic mass (SM), which is provided for converting a physical input variable into an electrical sensor output signal of the micromechanical sensor. According to an example embodiment of the present invention, the method includes the following steps: evaluating the sensor output signal of the micromechanical sensor for detecting harmful vibrations, which distort a recalibration of the micromechanical sensor; and interrupting the recalibration of the micromechanical sensor as soon as a harmful vibration has been detected.

The method according to the present invention does not aim to compensate for vibrations, but to recognize harmful vibrations in order to perform or terminate a compensation mechanism or a sensor recalibration.

The method according to the present invention increases the reliability and measurement accuracy of the micromechanical sensor and makes it considerably more robust against external environmental influences, in particular against vibrations.

In a possible embodiment of the present invention of the method for monitoring the state of a micromechanical sensor, the sensor output signal of the micromechanical sensor is evaluated to determine whether at least one predefined termination criterion for interrupting the recalibration of the micromechanical sensor is fulfilled.

By using and defining various termination criteria, the method according to the present invention can be used flexibly for a large number of different types of applications and differently constructed micromechanical sensors.

In a possible embodiment of the present invention of the method for monitoring the state of a micromechanical sensor, the termination criterion for interrupting the recalibration of the micromechanical sensor comprises the sensor output signal of the micromechanical sensor exceeding a defined threshold value.

A suitable threshold value can be ascertained in test runs.

In a possible embodiment of the present invention of the method for monitoring the state of a micromechanical sensor, the sensor output signal of the micromechanical sensor for evaluating the sensor output signal is stored temporarily.

This facilitates data processing and allows different termination criteria, which can also be linked to one another logically, to be applied in parallel or simultaneously.

In a possible embodiment of the present invention of the method for monitoring the state of a micromechanical sensor, the micromechanical sensor comprises at least one micromechanical gyroscope, which provides an angular velocity signal as a sensor output signal.

Gyroscopes are widely used and particularly sensitive to vibrations. The state monitoring according to the present invention therefore significantly increases the reliability of the monitored micromechanical gyroscope.

In a possible embodiment of the present invention of the method for monitoring the state of a micromechanical sensor, the micromechanical sensor comprises at least one micromechanical acceleration sensor, which provides an acceleration signal of a linear acceleration as a sensor output signal.

Micromechanical acceleration sensors are also widely used and sensitive to vibrations. The state monitoring according to the present invention therefore noticeably increases the reliability and accuracy of a monitored micromechanical acceleration sensor.

In a possible embodiment of the present invention of the method for monitoring the state of a micromechanical sensor, the sensor output signal of the micromechanical sensor is subjected to a drift analysis and/or a statistical check of average values, standard deviations, minimum and maximum values in order to determine whether at least one predefined termination criterion for interrupting the recalibration of the micromechanical sensor is fulfilled.

The multitude of available signal evaluation methods allows the method according to the present invention to be adjusted flexibly to differently constructed micromechanical sensors for different application areas.

In a possible embodiment of the present invention of the method for monitoring the state of a micromechanical sensor, the sensor output signal of the micromechanical sensor is evaluated by fast Fourier transforms FFT or wavelet transforms in order to detect distortions in undesired frequency ranges.

The additional signal evaluation in the frequency domain increases the reliability of the method according to the present invention with regard to the recognition of harmful environmental influences, in particular vibrations, on the recalibration of the micromechanical sensor.

In a possible embodiment of the present invention of the method for monitoring the state of a micromechanical sensor, the recalibration of the micromechanical sensor is initiated by a start signal actively triggered by a user and/or is initiated by at least one defined sensor event and/or is initiated automatically at defined time intervals.

This allows the method according to the present invention to be used flexibly in a multitude of application scenarios.

In a possible embodiment of the method for monitoring the state of a micromechanical sensor, the recalibration of the micromechanical sensor is initiated after the sensor has been installed in a device.

This allows the micromechanical sensor to be recalibrated in a robust manner at the end of an assembly line or production process of a device.

In a possible embodiment of the present invention of the method for monitoring the state of a micromechanical sensor, the recalibration of the micromechanical sensor is initiated during sensor operation.

This makes it possible to recalibrate the micromechanical sensor efficiently and permanently in the field when used at a customer's site.

In a possible embodiment of the present invention of the method for monitoring the state of a micromechanical sensor, the sensor output signal of the micromechanical sensor is evaluated both before the sensor recalibration and after the sensor recalibration of the micromechanical sensor for detecting harmful vibrations.

This is useful if the design of the micromechanical sensor does not allow state monitoring of the micromechanical sensor during its recalibration.

In a possible embodiment of the present invention of the method for monitoring the state of a micromechanical sensor, the recalibration of the micromechanical sensor is performed if the sensor output signal of the micromechanical sensor does not fulfill any defined termination criterion before the sensor recalibration or after the sensor recalibration of the micromechanical sensor.

In a possible embodiment of the present invention of the method for monitoring the state of a micromechanical sensor, the sensor output signal of the micromechanical sensor is evaluated during the sensor recalibration for detecting harmful vibrations.

This offers the advantage that the recalibration can be carried out at any point in time without interruption, without interrupting an ongoing vibration recognition running in the background.

In a possible embodiment of the present invention of the method for monitoring the state of a micromechanical sensor, the recalibration of the micromechanical sensor is performed if the sensor output signal of the micromechanical sensor does not fulfill any defined termination criterion during the sensor recalibration.

According to a second aspect, the present invention furthermore provides a micromechanical sensor.

The present invention provides a micromechanical sensor with a spring-mounted seismic mass, which is provided for converting a physical input variable into an electrical sensor output signal of the micromechanical sensor, and with a state monitoring unit, which is designed to evaluate the sensor output signal of the micromechanical sensor for detecting harmful vibrations, which distort a recalibration of the micromechanical sensor, and is designed to automatically interrupt the recalibration of the micromechanical sensor as soon as a harmful vibration has been detected.

In a possible embodiment of the present invention of the micromechanical sensor, the micromechanical sensor comprises at least one micromechanical gyroscope, which generates an angular velocity signal as a sensor output signal.

In a possible embodiment of the present invention of the micromechanical sensor, the micromechanical sensor comprises an acceleration sensor, which generates an acceleration measurement signal as a sensor output signal.

Other micromechanical sensors can also be monitored, in particular those that contain a detection mass SM, for example pressure sensors.

According to a further aspect, the present invention provides a device.

The present invention accordingly provides a device with at least one micromechanical sensor. According to an example embodiment of the present invention, the device includes a spring-mounted seismic mass, which is provided for converting a physical input variable into an electrical sensor output signal of the micromechanical sensor, and which comprises a state monitoring unit, which is designed to evaluate the sensor output signal of the micromechanical sensor for detecting harmful vibrations, which distort a recalibration of the micromechanical sensor, and is designed to automatically interrupt the recalibration of the micromechanical sensor as soon as a harmful vibration has been detected.

The device can be any electronic device that comprises one or more micromechanical sensors. The method according to the present invention can be controlled by a controller of the device. This controller comprises, for example, a processor or an ASIC. The state monitoring unit can also be integrated in the controller of the device.

Furthermore, possible embodiments of the method according to the present invention and of the micromechanical sensor according to the present invention are described in detail below with reference to the figures.

### BRIEF DESCRIPTION OF THE DRAWINGS

FIG. 1A is a simple flow chart for representing a possible embodiment of the method according to the present invention.

FIG. 1B is a schematic representation of a possible exemplary embodiment of a sensor in which the method according to the present invention shown in FIG. 1A is applied.

FIG. 1C is a schematic representation for explaining a possible embodiment variant of the method according to the present invention.

FIG. 2 is a signal diagram for explaining a possible embodiment of the method according to the present invention.

FIGS. 3A-3C are diagrams for explaining a possible embodiment of the method according to the present invention.

FIG. 4 is a signal diagram for explaining a possible embodiment of the method according to the present invention.

FIG. 5 is a signal diagram for explaining a possible embodiment of the method according to the present invention.

FIGS. 6-10 are signal diagrams for explaining further possible embodiments of the method according to the present invention.

### DETAILED DESCRIPTION OF EXAMPLE EMBODIMENTS

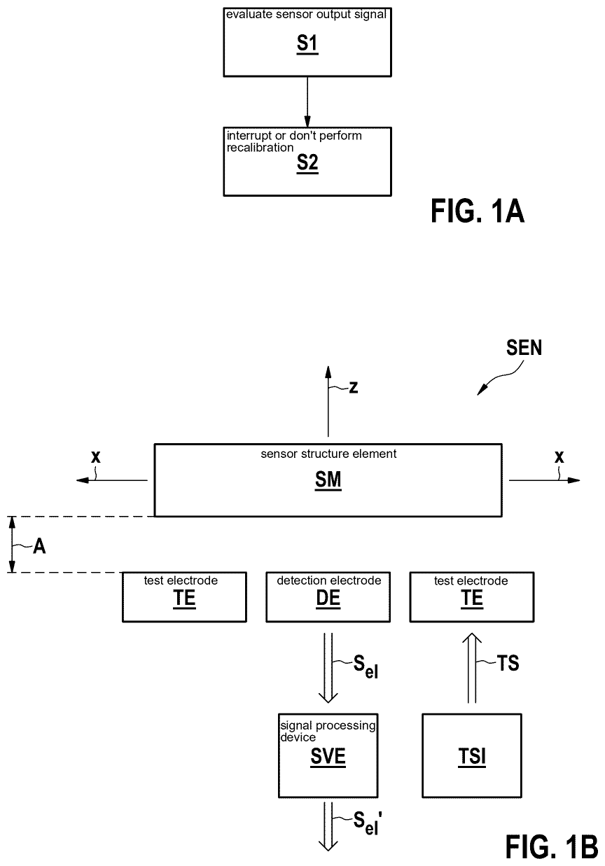

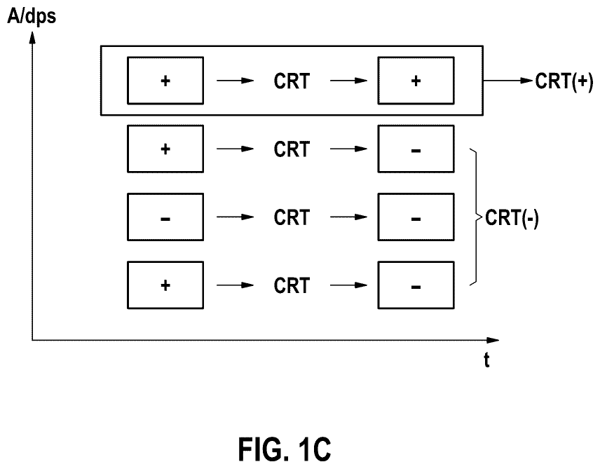

As can be seen in the flow chart according to FIG. 1A, the method according to the present invention substantially comprises two main steps S.

The method shown in FIG. 1A is used for monitoring the state of a micromechanical sensor SEN comprising a spring-mounted seismic mass (SM), which is provided for converting a physical input variable into an electrical sensor output signal of the micromechanical sensor.

In a first step S1 of the method shown in FIG. 1A, a sensor output signal of the monitored micromechanical sensor SEN is evaluated for detecting harmful vibrations, which distort a recalibration of the micromechanical sensor.

In a preferred embodiment of the method, the sensor output signal of the micromechanical sensor SEN for evaluating of the sensor output signal is first stored temporarily in a data memory. For this purpose, the sensor output signal is sampled in a possible implementation by an analog-to-digital converter and the sampled sensor output signal samples are stored temporarily in a data memory as samples for the subsequent evaluation in step S1.

The temporarily stored sensor output signal of the micromechanical sensor SEN is evaluated in step S1 to determine whether at least one predefined termination criterion AK for interrupting the recalibration of the micromechanical sensor is fulfilled. In a possible embodiment, the used termination criterion AK for interrupting the recalibration of the micromechanical sensor comprises the sensor output signal of the micromechanical sensor SEN exceeding a defined threshold value SW.

In a possible embodiment of the method for monitoring the state of a micromechanical sensor SEN, the sensor output signal of the micromechanical sensor SEN is subjected to a drift analysis and/or a statistical check of average values, drift deviations, minimum and maximum values in step S1 in order to determine whether at least one predefined termination criterion AK for interrupting the recalibration of the micromechanical sensor SEN is fulfilled.

In a possible embodiment of the method for monitoring the state of a micromechanical sensor SEN, the sensor output signal of the micromechanical sensor is evaluated with the aid of a fast Fourier transform FFT or wavelet transform in step S1 in order to detect distortions in undesired frequency ranges.

In a second step S2 of the method shown in FIG. 1A for monitoring the state of a micromechanical sensor SEN, the recalibration of the micromechanical sensor SEN is automatically interrupted or not performed as soon as a harmful vibration has been detected in step S1.

In a possible embodiment or variant of the method for monitoring the state of a micromechanical sensor SEN, the sensor output signal of the micromechanical sensor SEN is evaluated in step S1 both before the sensor recalibration and after the sensor recalibration of the micromechanical sensor SEN for detecting harmful or distorted vibrations. In this first variant, the recalibration of the micromechanical sensor SEN is only performed if the sensor output signal of the micromechanical sensor SEN does not fulfill any defined termination criterion AK before the sensor recalibration or after the sensor recalibration of the micromechanical sensor SEN.

In an alternative embodiment or variant of the method for monitoring the state of a micromechanical sensor, the sensor output signal of the micromechanical sensor SEN is evaluated in step S1 during the ongoing sensor recalibration for detecting harmful vibrations. In this second variant, the recalibration of the micromechanical sensor SEN is performed if the sensor output signal of the micromechanical sensor SEN does not fulfill any defined termination criterion AK during the sensor recalibration.

In a possible embodiment of the method for monitoring the state of a micromechanical sensor, the monitored micromechanical sensor SEN comprises at least one micromechanical gyroscope, which provides an angular velocity signal WGS as a sensor output signal.

In a possible embodiment of the method for monitoring the state of a micromechanical sensor SEN, the monitored micromechanical sensor SEN comprises at least one micromechanical acceleration sensor, which provides an acceleration signal of a linear acceleration as a sensor output signal.

In a possible embodiment of the method for monitoring the state of a micromechanical sensor SEN, the recalibration of the micromechanical sensor SEN is initiated by a start signal actively triggered by a user and/or is initiated by at least one defined sensor event and/or is initiated automatically at defined time intervals.

In a possible further embodiment of the method for monitoring the state of a micromechanical sensor, the recalibration of the micromechanical sensor SEN is initiated after the sensor has been installed in a device.

In a possible further embodiment of the method for monitoring the state of a micromechanical sensor SEN, the recalibration of the micromechanical sensor SEN is initiated during ongoing sensor operation.

According to a further aspect, the present invention furthermore provides a micromechanical sensor SEN with a spring-mounted seismic mass SM, which is provided for converting a physical input variable into an electrical sensor output signal of the micromechanical sensor SEN, and with an integrated or connected state monitoring unit, which is designed to evaluate the sensor output signal of the micromechanical sensor SEN for detecting harmful vibrations, which distort a recalibration of the micromechanical sensor SEN, and is designed to automatically interrupt the recalibration of the micromechanical sensor SEN as soon as a harmful vibration has been detected.

In a possible embodiment of the micromechanical sensor, the micromechanical sensor SEN comprises at least one micromechanical gyroscope, which generates an angular velocity signal WGS as a sensor output signal.

In a further possible embodiment of the micromechanical sensor, the micromechanical sensor SEN comprises an acceleration sensor, which generates an acceleration measurement signal as a sensor output signal.

FIG. 1B schematically shows a gyroscope or a rotation rate sensor, which can be monitored by means of the method according to the present invention.

A gyroscope as a sensor usually measures the rotation rate or the angular velocity ω and not the orientation or the rotation angle. If the gyroscope rotates around itself once in one second, an angular velocity WG of 360 degrees/s is measured.

Rotation rate sensors are inertial sensors that can measure the angular velocity WG without an external reference. Vibration gyroscopes use the Coriolis effect, which occurs due to the vibration enforced in the MEMS and due to an existing angular velocity WG.

The method according to the present invention relates to measures for recalibrating a micromechanical sensor SEN, whose sensor structure comprises at least one deflectable sensor structure element SM for detecting and converting a physical input variable into an electrical sensor signal.

On the gyroscope shown in FIG. 1B as a rotation rate sensor SEN, a recalibration or a sensitivity compensation can be performed. The relationship between the actual angular velocity WG and the gyroscope output signal (measured angular velocity) is referred to as the sensitivity error. The sensitivity of a gyroscope depends on the reaction of the test mass or seismic mass SM to the Coriolis force FC, which may be different for each produced MEMS gyroscope due to small differences in the production process. The sensitivity of a MEMS gyroscope is trimmed to the value one during the production process. After calibration, the sensitivity is not exactly equal to one, since the micromechanical sensor SEN is in a different electromagnetic and mechanical environment after calibration. Additional deviations in sensitivity can be caused by soldering and over the operating life of the micromechanical sensor SEN. This leads to deterioration of the sensitivity error of the micromechanical sensor SEN and can be compensated by calibrating or recalibrating the sensor or by a sensor recalibration method (component re-trim).

The monitored micromechanical sensor SEN can, for example, be an inertial sensor for detecting accelerations or a rotation rate. The sensor structure of an inertial sensor usually comprises at least one spring-mounted seismic mass SM, the deflections of which are acquired.

In the case of an acceleration sensor, these deflections are directly due to the acceleration to be acquired. In the case of a micromechanical rotation rate sensor SEN or gyroscope, as shown schematically in FIG. 1B, the seismic mass SM of the micromechanical rotation rate sensor SEN is actively excited to vibrate in an excitation plane for detection purposes. Rotational movements of the micromechanical sensor SEN about an axis that is oriented in parallel with the excitation plane and perpendicularly to the excitation direction can then be acquired as deflections of the seismic mass SM perpendicular to this excitation plane, since such rotational movements induce a Coriolis force FC that acts on the seismic mass SM perpendicularly to the excitation plane.

In particular, if such an inertial sensor is to acquire accelerations or rotation rates in more than just one spatial direction, the sensor structure of the micromechanical rotation rate sensor SEN or gyroscope often comprises not just one, but a plurality of seismic masses SM, the suspensions of which are then particularly flexible in a different spatial direction in each case.

The sensor structure of a micromechanical rotation rate sensor SEN comprises at least one seismic mass SM as a detection element, which is connected to the rest of the sensor structure via a spring arrangement. The seismic mass as a detection element is denoted by SM in the schematic representation of FIG. 1B. The rotation rate sensor is equipped with drive means, with the aid of which the spring-mounted detection element or the seismic mass SM can be set into vibration with a certain excitation frequency ωA.

When the detection element SM, which vibrates in the x direction, rotates about an axis oriented in the y direction, which is perpendicular to the image plane in FIG. 1B, a Coriolis force FC occurs. This Coriolis force FC acts in the z direction and is proportional to the rotation rate Q of the rotational movement. This Coriolis force FC excites the detection element SM, which vibrates in the x direction, to additionally vibrate in the z direction. The frequency of this vibration in the z direction corresponds to the excitation frequency ωA, but the vibration is 90° out of phase with the excitation vibration of the detection element SM in the x direction. The vibrational movement of the detection element SM in the z direction can be acquired as a sensor output signal and fed to a signal processing device SVE assigned to the micromechanical sensor SEN or integrated therein, in order to determine the rotation rate Q of the rotational movement therefrom.

In the exemplary embodiment shown in FIG. 1B, the sensor signal is acquired capacitively with the aid of a detection electrode DE, which is arranged opposite the detection element or the seismic mass SM in the z direction, namely at a distance A, as shown schematically in FIG. 1B. Together with the detection element SM, the detection electrode DE forms a detection capacitor. The distance A changes periodically with the vibrational movement of the detection element SM in the z direction that is caused by the Coriolis force FC. The associated capacitance change of the detection capacitor is output as a sensor signal of the rotation rate sensor or gyroscope shown schematically in FIG. 1B.

The sensor signal of such a micromechanical rotation rate sensor SEN, as shown schematically in FIG. 1B, can be influenced by a number of further, mostly undesired parameters. For example, fluctuations in the layer thicknesses of the sensor structure, which occur due to the MEMS production process, play a role. The packaging can also affect the sensor signal of the micromechanical rotation rate sensor SEN, for example if it introduces mechanical stresses into the sensor structure.

A calibration process is used to recalibrate a micromechanical sensor SEN with a micromechanical sensor structure that comprises at least one deflectable sensor structure element or a deflectable seismic mass SM, which is provided for detecting and converting a physical input variable into an electrical sensor signal.

The detection electrode DE of the micromechanical sensor SEN shown in FIG. 1B is provided for acquiring the test deflection of the seismic mass SM as an electrical sensor response signal Sel. A signal processing device SVE for correcting the electrical sensor signal Sₑₗ is assigned to the sensor SEN. The signal processing device SVE can be embedded or integrated in the sensor. In a possible implementation, the electrical sensor output signal Sₑₗ is corrected on the basis of at least one predetermined initial trim value Cal (0), which is selected such that a production-related deviation of the sensor signal from a target sensor signal is compensated when the sensor is excited in a defined manner. The signal processing device SVE provides the corrected electrical sensor signal Sₑₗ′.

In a possible embodiment, the recalibration of the micromechanical sensor SEN shown in FIG. 1B comprises a plurality of calibration steps. First, a defined electrical test excitation signal, in particular a defined direct voltage U_{DC}, is applied to the sensor structure with the aid of at least one test electrode TE, which causes a test deflection of the seismic mass SM of the micromechanical sensor SEN. The detector electrode DE of the micromechanical sensor SEN acquires the test deflection as a capacitance change and provides a corresponding electrical sensor response signal Sₑₗ (i). A trim correction value Δcal (i) for an initial trim value Cal (0) is ascertained on the basis of a predetermined relationship between the sensor response signal Sₑₗ and the trim correction value. Finally, at least one current trim value Cal (i) for the correction of the sensor signal is determined on the basis of the at least one initial trim value Cal (0) and the ascertained trim correction value Δcal (i).

The micromechanical rotation rate sensor SEN shown schematically in FIG. 1B is equipped with test electrodes TE, which are preferably arranged in the same plane as the detection electrode DE but laterally from this detection electrode DE. By applying a defined electrical voltage U between the seismic mass SM as the detection element and the test electrodes TE, a defined electrical test excitation in the z direction can be exerted on the detection element or on the seismic mass SM. The corresponding sensor response signal or sensor output signal Sel is acquired as a capacitance change between the detection electrode DE and the seismic mass SM. The sensor response signal Sel (i) can also be referred to as the electrical sensitivity of the sensor SEN at the measurement time i.

In a possible embodiment, an electrical DC voltage U is applied between the detection element SM and the test electrodes TE, so that the corresponding electrostatic force acts in the z direction, i.e., in the detection direction, i.e., in the direction of the Coriolis force FC. Due to the arrangement and geometry of the test electrodes TE, this force is modulated with the driving vibrational movement of the seismic mass SM. This electrostatic force therefore has the same frequency f and also the same phase as the driving vibrational movement of the seismic mass SM. However, it is 90° out of phase with the Coriolis force FC induced by a rotational movement. That is to say, by applying the DC voltage U, a quadrature force is electrically induced. The resulting deflection of the seismic mass SM can be acquired separately by demodulating the sensor output signal. The amplitude of this portion of the sensor signal is then output as a static electrical sensor response signal Sel.

With the aid of the recalibration, the sensor sensitivity of the micromechanical sensor SEN shown in FIG. 1B can always be returned to the initial sensor sensitivity, i.e., the physical sensitivity can always be corrected by the recalibration, to its new part value if possible.

The recalibration of the micromechanical sensor SEN shown in FIG. 1B makes it possible to easily compensate for the influence of assembly-related mechanical stresses on the measurement signal or sensor output signal and is therefore preferably used in an application environment after the micromechanical rotation rate sensor SEN shown in FIG. 1B has been installed. However, the micromechanical sensor SEN can also be recalibrated during ongoing sensor operation of the micromechanical sensor SEN in the field, in order to compensate for the influence of changing environmental conditions on the measurement signal or sensor output signal. For this purpose, the electrical excitation of the detection mass SM of the micromechanical sensor SEN can, for example, be carried out at regular intervals or be triggered automatically by defined sensor events, such as shortly before the rotation rate sensor is switched off after the micromechanical sensor SEN has received the switch-off signal.

Finally, the recalibration of the micromechanical sensor SEN can also be initiated by the user of the device in which the micromechanical rotation rate sensor SEN is installed.

Using the example of the sensor recalibration of the micromechanical sensor SEN shown in FIG. 1B, the electrodes used to measure the sensitivity deviation of the angular velocity WG are particularly sensitive to vibration-induced angular movements.

There are two different procedures or variants for performing the recalibration of such a micromechanical sensor SEN.

Variant 1: The electrodes can be sensitive either to the test signal or to the angular velocity WG, since the test signal and the angular velocity are 90° out of phase with each other.

During the sensor recalibration, the test signal TS must be acquired for the calculation of the gain compensation coefficient. The angular velocity WG therefore cannot be measured during the sensor recalibration. However, the correct criterion for the movement threshold SW is based on a processed angular velocity signal WGS. In the first variant, this angular velocity signal is measured in step S1 of the method according to the present invention before and after performing the sensor recalibration, as also shown schematically in FIG. 1C (sensor amplitude in dps (degrees per second) over time t). The sensor recalibration is only carried out if stability exists before and after (+, +). If there is no stability before or after, the sensor recalibration is terminated.

If a predefined movement threshold value SW of the processed angular velocity signal WGS is not reached both before and after the sensor recalibration or a corresponding termination criterion AK is not fulfilled, the sensor recalibration is performed, otherwise it is terminated in step S2 of the method according to the present invention, as also shown schematically in FIG. 1C.

Variant 2: The electrodes are sensitive to both the test signal TS and the angular velocity WG. In the second variant, the movement threshold SW can be evaluated in step S1 of the method according to the present invention during the sensor recalibration. If the movement threshold SW of the processed angular velocity signal WGS is not reached or a corresponding termination criterion AK is not fulfilled, the sensor recalibration is carried out in step S2, otherwise it is terminated.

Conventionally used sensor recalibration termination thresholds SW are usually based on a linear acceleration measurement. The threshold value SW used is usually narrow and can lead to the sensor calibration being terminated even if such a termination is not actually necessary. The application of such a simple termination criterion AK, for example in SMT assembly lines (e.g., at smartphone or wearable manufacturers' sites), can therefore lead to unnecessary errors as well as to a production with a high error rate or increased testing time or even both. By means of a linear acceleration threshold as a termination criterion AK, it is not possible to recognize any critical angular movement that leads to deterioration of the sensitivity error of the micromechanical sensor SEN.

In addition to using the angular velocity signal WGS as a criterion for the movement threshold SW, it is also possible to use the signal during the sensor recalibration instead.

In the second procedure or variant (variant 2), the measured signal or sensor output signal of the micromechanical sensor SEN contains information about the test signal TS and about the angular velocity WG caused by external forces F. By analyzing the measurement signal or sensor output signal of the micromechanical sensor SEN, it is possible to distinguish which part of the sensor output signal is due to the test signal TS and which part of the sensor output signal is due to or caused by external forces or vibrations. The termination criterion AK can therefore be a detected high proportion of the external forces F or vibrations in the sensor output signal of the micromechanical sensor SEN during the sensor recalibration. If the influence of the external forces F on the measurement signal or the sensor output signal Is too great, the sensor recalibration is automatically terminated in step S2, otherwise it is continued.

According to one aspect, the present invention provides a device with at least one micromechanical sensor SEN, which comprises a spring-mounted seismic mass (SM), which is provided for converting a physical input variable into an electrical sensor output signal of the micromechanical sensor SEN, and which comprises an embedded or connected state monitoring unit, which is designed to evaluate the sensor output signal of the micromechanical sensor SEN for detecting harmful vibrations, which distort a recalibration of the micromechanical sensor SEN, and is designed to automatically interrupt the recalibration of the micromechanical sensor SEN as soon as a harmful vibration has been detected. The device is, for example, a portable user end device, such as a mobile phone device.

Depending on the application, different compensation methods or recalibration methods can be performed for acceleration sensors, gyroscopes, or other IMUs (inertial measurement units).

A possible compensation method relates to a fast offset compensation or fast offset calibration (FOC) of acceleration sensors. MEMS acceleration sensors SEN consist of a spring-mass-damper system in which a test mass SM is deflected as soon as it is exposed to external acceleration forces F. The deflection of the test mass SM can be measured with the aid of capacitive acquisition electrodes and corresponding signal processing. The offset of a MEMS acceleration sensor SEN is typically susceptible to changes in the mechanical housing stress caused, e.g., by soldering the sensor onto a circuit board, so that offset compensation is required at the end of the production line or in the field. In offset compensation methods such as fast offset calibration (FOC), the actual offset is measured by recording an acceleration signal. The acceleration sensor must therefore be in a rest position and must not be exposed to any vibrations while acquiring the signal required for the determination of the offset. In a possible embodiment of the method according to the present invention, the correct rest position is checked by measuring suitable signals and comparing them with a threshold value. The offset compensation or fast offset calibration (FOC) is performed on acceleration sensors. This offset compensation can be performed, for example, in the production line of customers in order to compensate for offset drifts after soldering the micromechanical sensor onto a circuit board.

A further possible compensation method relates to offset compensation in the case of gyroscopes. The gyroscope measures the angular velocity WG, which can then be used, e.g., for position and orientation measurements or for image stabilization. MEMS gyroscopes as micromechanical sensors SEN operate on the basis of a sinusoidal Coriolis force FC, which is generated by the vibration of a test mass or seismic mass SM in conjunction with an orthogonal angular velocity input. The overall dynamic system is typically a mass-spring-damper system with two degrees of freedom (2 DOF), in which the energy transfer to the sensor mode is carried out by the rotation-induced Coriolis force FC proportionally to the angular velocity. When the gyroscope is in the rest position, the offset corresponds to the measured angular velocity WG.

Offset compensation can be performed on micromechanical rotation rate sensors SEN or gyroscopes. This compensation is performed, e.g., in the production line of customers in order to compensate for offset deviations after soldering the micromechanical sensor SEN onto a circuit board.

A further possible compensation method relates to the recalibration of the sensitivity and offset of acceleration sensors. During end-of-line trimming and testing, the acceleration sensor signal is trimmed in a well-known environment. In addition to the signals in the normal operating mode, further signals are recorded, e.g. a built-in excitation reaction on electrostatic force (BITE), a specific test mode for measuring the base capacitance Co, raw offset and raw sensitivity in different FE modes, tests for precisely determining mechanical parameters of the MEMS component, such as the natural frequency and the damping ratio. All results can be stored in a data memory of the device as a reference for comparison for the calibration in the field. In the field, these tests or a subset thereof are performed and, with the aid of correlation techniques or machine learning ML algorithms, the device is recalibrated and sensitivity and offset errors are minimized.

In a possible implementation, the sensor recalibration in step S2 of the method according to the present invention shown in FIG. 1A can use a physical test signal (e.g., a test quadrature signal) to measure and correct a sensitivity deviation and thus minimize the sensitivity error of the micromechanical sensor SEN.

Movements of sensors, in particular vibrations, can influence the movement of the electrodes and thus the signal. This leads to deterioration of the measurement of the sensor parameters that must be compensated. This is the case, for example, with compensation methods that use sensor recalibration.

In order to ensure compliance with certain environmental conditions, the method according to the present invention carries out built-in state monitoring. For recognizing vibrations that lead to a distortion of the sensor signal, a possible embodiment uses a detection mechanism with a predefined threshold value SW for harmful vibrations.

The harmful vibrations to be detected can occur in six dimensions, namely three linear movement directions and three angular movement directions.

The three linear movement directions can be covered by corresponding micromechanical acceleration sensors, and the angular movement directions can be covered by three corresponding micromechanical gyroscopes.

If a detection mechanism acquires vibrations or mechanical vibrations that are below a defined threshold value SW, the compensation or recalibration is performed; otherwise, the compensation or recalibration is terminated in step S2 of the method shown in FIG. 1A.

One challenge is to provide a suitable termination criterion AK, in particular a suitable movement threshold SW.

Existing acceleration sensors can be used for monitoring mechanical influences on the micromechanical sensor SEN. If a plurality of axes are available during the method, axes that are not used during recalibration can be used for monitoring the vibration or movement influences of the environment on the micromechanical sensor SEN. In some sensor configurations, more than one axis per direction is available. Examples in this respect are different sensor cores per axis, which are optimized for different acceleration ranges or for different signal bandwidths. Therefore, every time a signal is recalibrated, all other signals are also monitored and their signals are evaluated or assessed.

During the signal evaluation in step S1 of the method shown in FIG. 1A, different methods for signal monitoring can be used. In a possible implementation, these signal monitoring methods comprise a drift analysis over time for recognizing movements, statistical methods for checking average values, checking of standard deviations, monitoring of minimum and maximum values for detecting unwanted influences on the micromechanical sensor SEN.

Recorded sensor signals of the micromechanical sensor SEN can be evaluated in step S1 of the method by fast Fourier transforms FFT or wavelet transforms in order to detect distortions in undesired frequency ranges.

In general, all monitored signals can be used in classification methods to distinguish whether the environmental conditions are suitable for the application of a recalibration method or whether they are used as termination criteria.

For each of the three angular movement directions, a gyroscope signal from a micromechanical rotation rate sensor SEN is preferably used. A processed angular movement signal can therefore be used as a reliable measure.

By using a suitable predefined threshold SW based on a processed linear acceleration signal or angular velocity signal, correct application of a compensation method or recalibration can be ensured.

The method according to the present invention can be used for recognizing a correct rest position for a sensitivity and offset recalibration of micromechanical acceleration sensors SEN.

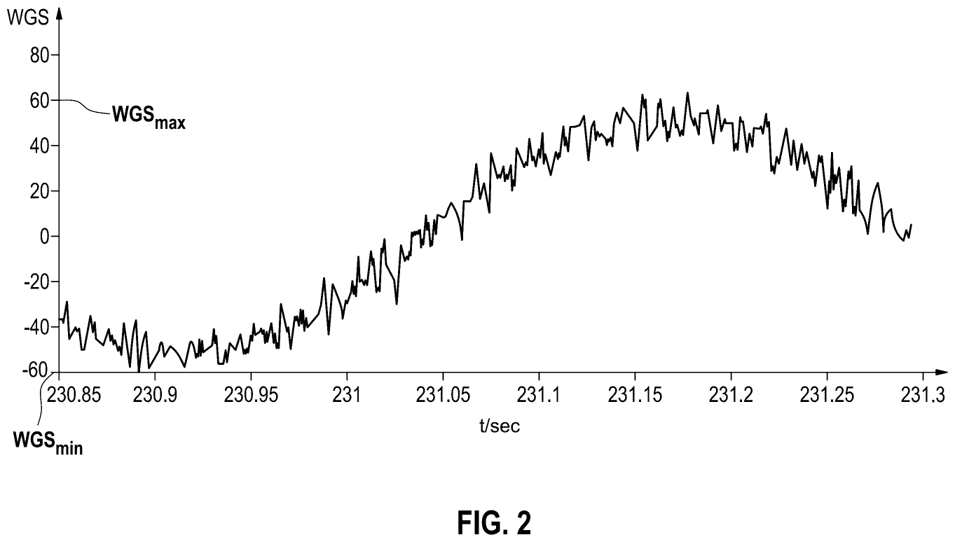

In this case, the sensor output signal of the micromechanical acceleration sensor SEN is recorded and a numerical signal characteristic curve is calculated. The signal characteristic curve is not limited to the difference between a minimum signal value and a maximum signal value shown in FIG. 2, but can be extended to any other signal characteristic curve ascertained, e.g., by a moving average or fast Fourier transform (FFT). In any case, the derived signal characteristic curve must be compared with an appropriate threshold value in order to decide whether the recalibration is in compliance with the specification.

For the three angular movement directions, the gyroscope output signal is used as a recognition mechanism. The gyroscope output signal is processed in order to derive a threshold value SW.

For the application of the sensor recalibration, various signals in angular vibration measurements for all three axes with different amplitudes and different frequencies f can be examined and evaluated in detail. In a possible implementation, this has the result that in particular the following processed angular velocity signal WGS predicts a reliable threshold value SW.

During a certain time period (which is usually equal to the duration of a sensor recalibration run of, for example, 100 ms to 1000 ms), the angular velocity signal WGS is recorded and the WGS difference between the maximum angular velocity value WGSₘₐₓ and the minimum angular velocity value WGSₘᵢₙ is ascertained.

An example in this respect is shown in the signal diagram (channel values recorded before a CRT cycle at a stimulus of 2 Hz and 50 dps) of FIG. 2:

$$WGS - Diff = WGS max - WGS min$$

The processed angular velocity signal WGS according to FIG. 2 results in a difference value WGS-Diff of 62.7 dps−(−59 dps)=121 dps.

After detailed analysis, a threshold value SW of ˜50 dps can be derived for this example for the processed angular velocity signal WGS with a sensor calibration duration of 500 ms.

The electrodes of a micromechanical gyroscope, as shown in FIG. 1B, are sensitive to angular movements, since their function is to detect the deflection of the detection mass SM due to an angular velocity. Angular movements caused by unwanted vibrations during the calibration can therefore influence the test signal and thus lead to deterioration of the sensitivity error.

In a possible implementation, the correct performance of the sensor calibration is ensured if the gain drift (GD)=<2 LSB.

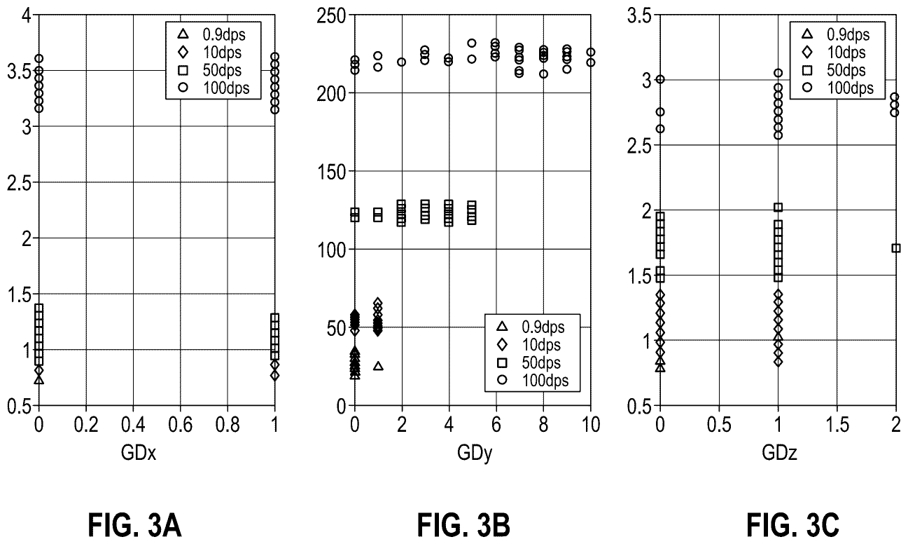

The gain drift GD is derived from the signal induced by the test electrodes TE and determines the factor for the sensitivity compensation. A good correlation between the processed angular velocity signal WGS and the gain drift GD is observed at a critical frequency f of 2 Hz. A suitable threshold value SW of approximately 50 dps can be derived therefrom, as can be seen in the signal diagrams (gyroscope delta versus gain drift GD with a sensor excited in the Y direction at 2 Hz) of FIG. 3A, 3B, 3C for various directions X, Y, Z.

The disadvantage of the above-described first procedure or variant (variant 1) of the method according to the present invention is that the angular velocity signal WGS cannot be determined during the sensor recalibration. A minimal risk therefore remains that compliance with the threshold value SW before and after the sensor recalibration is not sufficient (i.e., the threshold value SW is exceeded during the sensor recalibration).

However, since the sensor recalibration usually takes less than a second, it is relatively unlikely that a mechanical movement/vibration signal is only visible during and not before or after the sensor recalibration.

There is a further (second) procedure (variant 2) for reliably predicting the correct application of the sensor recalibration.

The signal recorded by the electrodes makes it possible to recognize the presence of mechanical vibrations that lead to deterioration of the sensitivity error compensation by sensor recalibration.

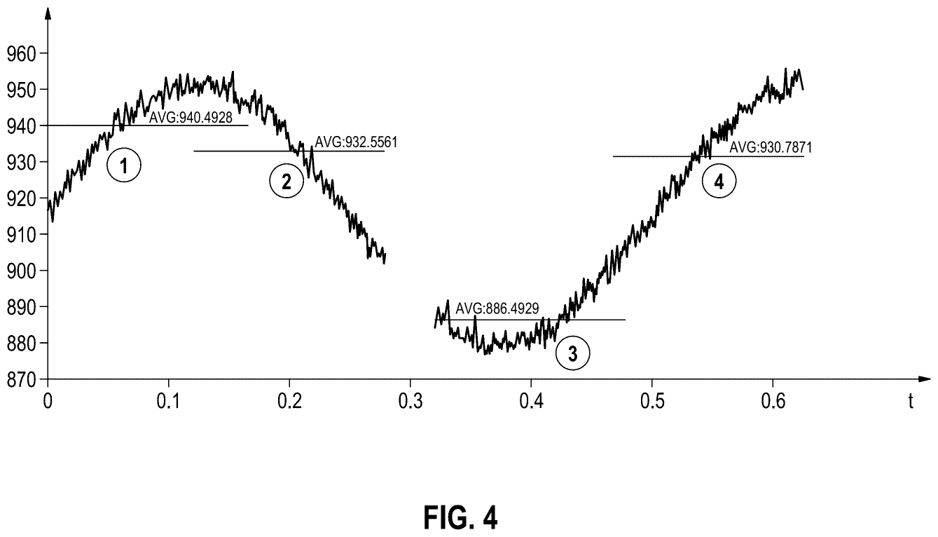

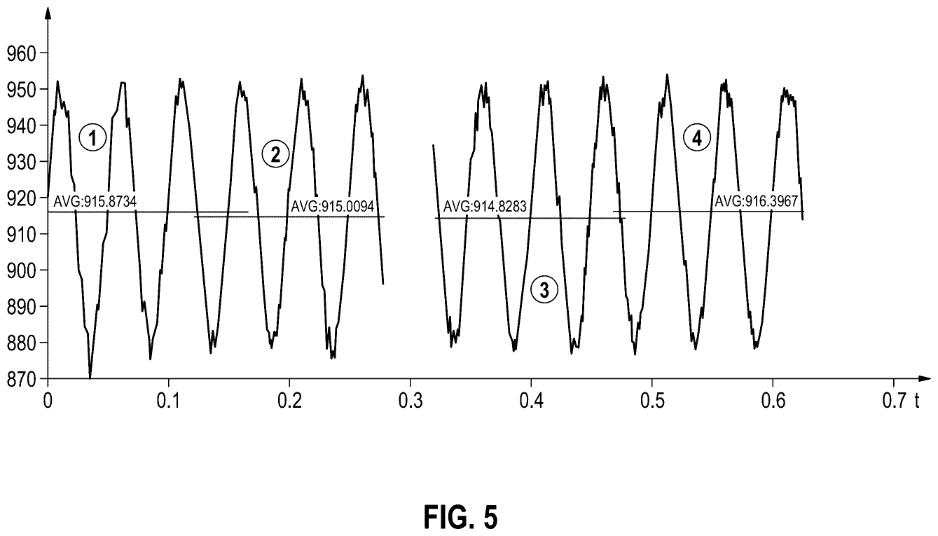

A comparison of the signal diagrams according to FIG. 4 (test quadrature signal with mechanical vibrations 2 Hz and 125 dps) and FIG. 5 (test quadrature signal with mechanical vibrations 20 Hz and 125 dps) shows that the average value (AVG) of the signal (here quadrature) recorded by the electrodes depends strongly on the phase of this signal. A fluctuating average value AVG of the signal recorded by the electrodes is an indicator of an insufficient rest position and leads to unreliable sensitivity error compensation by the sensor recalibration.

An algorithm that can distinguish between these two situations can be applied during the sensor recalibration and can provide a suitable indicator.

This offers two advantages over the first procedure:

On the one hand, there is no need to record the angular velocity signal WGS before and after, which reduces the time required for recalibrating the sensor and for ensuring the sensor recalibration.

On the other hand, the in-situ signal is used directly during the sensor recalibration process, thus avoiding the risk that only a signal shortly before or after the sensor recalibration can be used and that a harmful movement during the sensor calibration process may be missed.

It is possible to analyze the measured signal during the sensor recalibration. As described above, the measured signal is influenced both by the test signal and by external forces F.

The following shows how the measured signal behaves during the sensor recalibration for various angular velocities WG.

Thereafter, a possible way of processing the measurement signal or sensor output signal of the micromechanical sensor SEN is shown, and a series of features that can be used for a termination criterion AK is presented.

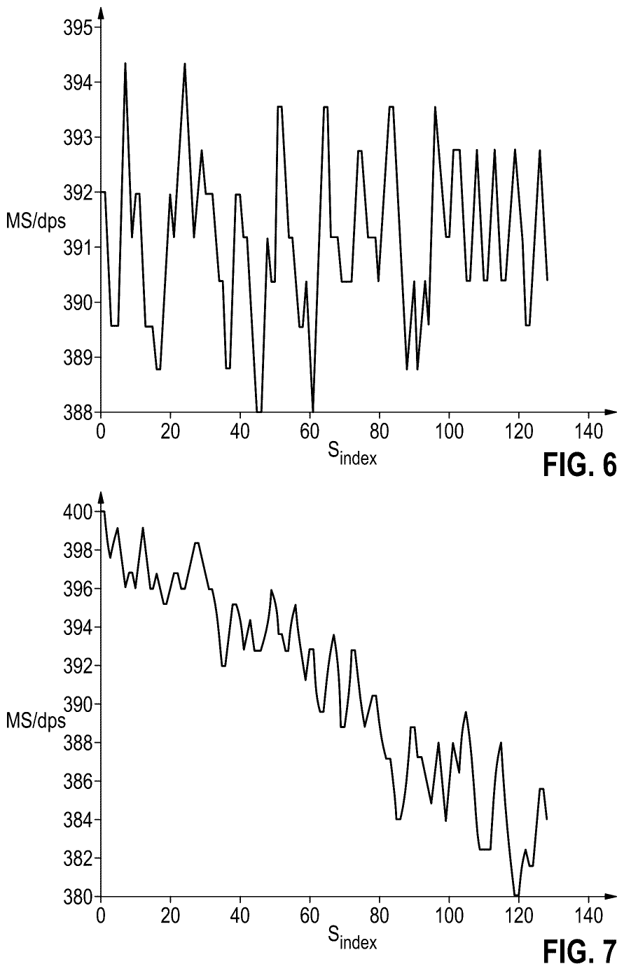

FIG. 6 shows the measured measurement signal values for various sensor recalibration runs when no external force F acts on the micromechanical sensor SEN.

The sample index S_{index} of the measured signal is plotted on the x-axis, and the y-axis specifies the measured value in dps. The dps values in the exemplary signal value curve shown in FIG. 6 are between 386.2 dps and 396 dps for various runs.

In contrast to the signal curve according to FIG. 7, the signal value curve shown in FIG. 6 does not show any drift of the measurement signal or sensor output signal during a sensor calibration run.

FIG. 7 shows the measured signal for a single sensor calibration run, in which an oscillating force F is exerted on the micromechanical sensor SEN. In this case, the micromechanical sensor SEN is rotated along one of its axes and the rotation direction is changed with a period of 2 Hz. In FIG. 7, it can be clearly seen that the external force F influences the measured signal, which leads to a drift of the measured signal with the underlying rotation frequency of the external force F.

In the case of the signal value curve according to FIG. 7, simple averaging, which is required for the sensor calibration, is not reliable.

The following description presents a possibility for assessing the drift of the measurement signal, in order to decide whether the sensor recalibration of the micromechanical sensor SEN should be terminated.

As already mentioned, the average value of the measurement value signal curve can be ascertained for the sensor recalibration.

The arithmetic mean M is defined in equation (1) as:

$$M = \frac{1}{N} {\sum }_{n = 1}^{N} {a}_{n} ,$$

where N is the number of samples and aₙ is the value of the n-th sample.

In connection with the sensor recalibration, a disadvantage of using equation (1) is that no time information is available. This means that only a single value is available for each sensor recalibration run.

In order to determine whether the arithmetic mean M drifts, this procedure therefore requires a plurality of sensor recalibration runs to be repeated, which prolongs the total calibration time of the micromechanical sensor SEN.

Since the repetition of a plurality of sensor recalibration runs leads to a higher time expenditure for the evaluation and execution, a preferred embodiment of the method according to the present invention therefore carries out an efficient method for determining the evaluation within one run, namely an iterative calculation of the arithmetic mean M.

The iterative calculation of the arithmetic mean M can be derived from equation (1).

The iterative calculation of the arithmetic mean M, which is also referred to as the cumulative average, is given by:

$${M}_{n} = {M}_{n - 1} + \frac{1}{n} ( {a}_{n} - {M}_{n - 1} ) , n ∈ [ 2 , … , N ] \qquad ( 2 )$$

$${M}_{1} = {a}_{1} \qquad ( 3 )$$

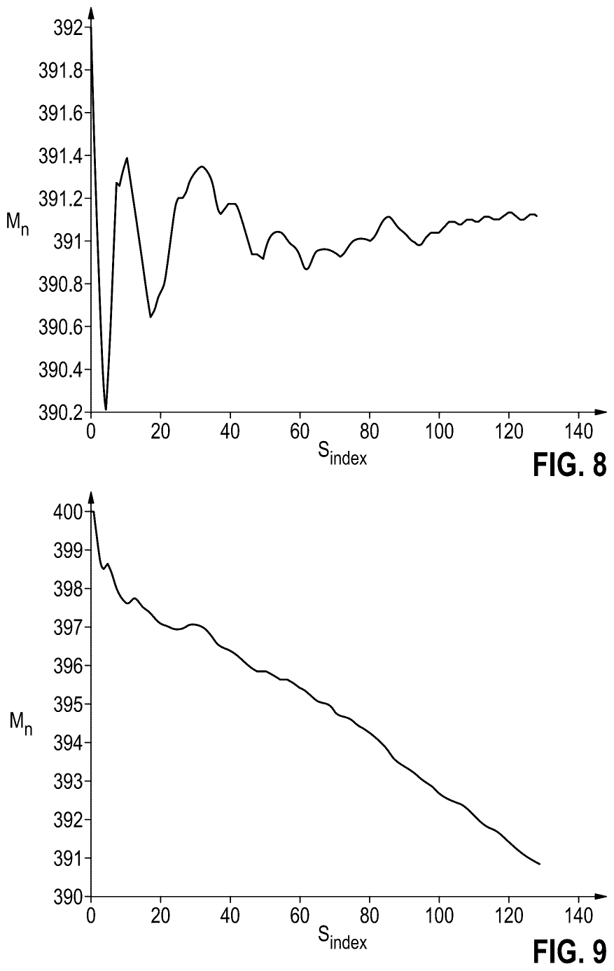

The use of equation (2) allows a better insight into the course of the arithmetic mean M over the entire sensor recalibration, as shown in the curves according to FIG. 8, 9.

FIG. 8 shows the cumulative average value Mₙ for the measured test quadrature signal of FIG. 6. The sample index S_{index} of the cumulative average value Mₙ is plotted on the x-axis, while the cumulative average value Mₙ, specified in dps, is plotted on the y-axis. As can be seen in FIG. 8, the cumulative average value Mₙ in the example shown converges in a range of 390.9 dps to 391.1 dps.

FIG. 9 shows the cumulative average value M, for the measured test quadrature signal of FIG. 7. In contrast to the curve in FIG. 8, the curve according to FIG. 9 clearly shows a drift of the cumulative average value Mₙ over the sample index S_{index}. If the cumulative average value Mₙ (as shown in FIG. 9) drifts, a possible embodiment of the method according to the present invention terminates the sensor recalibration in step S2, otherwise it can be continued.

In the following, a feature is introduced that can be used to determine how much the cumulative average value Mₙ drifts. However, other features can also be used. For the evaluation of the arithmetic mean, it is not of interest how much the measured signal fluctuates due to external forces F, but whether the effects of the external forces F average out during the sensor recalibration run.

One feature that provides this information is the number of times the minimum and maximum values of the cumulative average value Mₙ are updated. For n=1, the minimum and maximum values of the cumulative average value are set to the same value, namely the value a₁. When calculating M₂ in equation (2), it is checked whether the minimum and maximum values need to be updated. If the minimum value needs to be updated, a first counter Z1 for updating the minimum value is increased or incremented by one. If the maximum value needs to be updated, a second counter Z2 for updating the maximum value is increased or incremented by one. If neither the minimum value nor the maximum value of the cumulative average value needs to be updated, the value of the two counters Z1, 22 remains the same. The maximum value of the two updated counters Z1, 22 represents a feature that can be used to determine how much the cumulative average value Mₙ drifts over the sample index S_{index}. If this feature is applied to the cumulative average value curves in FIG. 8, the minimum and maximum values are updated up to a sample index S_{index} of five. The feature value is therefore five. In contrast, the minimum and maximum values of the cumulative average value Mₙ in FIG. 9 are updated more often.

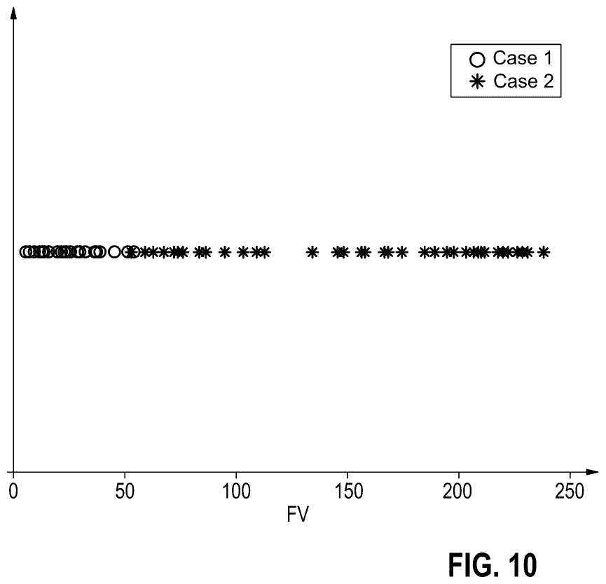

In FIG. 10, the feature value FV is plotted for various sensor recalibration runs, which are divided into two groups, namely case 1 and case 2.

Case 1 contains all the sensor recalibration runs in which no external force F is exerted on the micromechanical sensor SEN, i.e., all runs according to FIG. 8.

Case 2 contains all the sensor recalibration runs in which an oscillating rotational force F is exerted on the micromechanical sensor SEN.

Each circle in FIG. 10 represents a sensor recalibration run of case 1.

Each star in FIG. 10 represents a sensor recalibration run of case 2.

As can be seen in FIG. 10, the circles (case 1) and stars (case 2) form two groups, which are well separated from each other.

Only at a feature value FV of approximately 50 do the two groups overlap slightly. For this reason, a simple threshold value recognition on the basis of the feature value FV can be used to distinguish between these two groups.

If more statistical data are available, it is also possible to choose one of the two groups on the basis of their probability density functions. In addition, the feature presented above could also be combined with other features, which leads to a decision on the basis of a vector instead of a scalar.

The decision itself as to whether the sensor recalibration is terminated or continued in step S2 of the method according to the present invention can be a hard or a soft decision.

A soft decision provides additional information about the certainty of a particular decision. This additional information can be used to gain insights into the quality of the sensor recalibration, e.g., in the SMT assembly line. By monitoring the soft decision between different sensors, it is also possible to monitor whether there are changes in the environment in which the sensor recalibration is carried out. A decrease in the decision certainty indicates that disturbing environmental influences, in particular vibrations, have increased, and makes it possible to take countermeasures before the sensor recalibration is terminated.

A fast offset calibration FOC can be used for both gyroscopes and acceleration sensors of different customers.

The method according to the present invention uses detection mechanisms for recognizing vibrations or shocks that lead to deterioration of the original offset.

The signal monitoring for the recalibration of micromechanical acceleration sensors can be used in a variety of applications, depending on their configuration and the possibility of internal state monitoring and data evaluation. Especially high-performance IMUs can comprise a powerful processor capable of performing statistical evaluations, FFTs, wavelet transforms, and classification algorithms, which can be supported by inputs from machine learning (ML) algorithms.

The sensor recalibration of the micromechanical sensor SEN can be used for various applications:

The sensor recalibration can be used, for example, in an SMT assembly line to compensate for sensitivity errors after soldering. In this case, an algorithm for deciding whether the sensor recalibration should be terminated in step S2 of the method according to the present invention can run on an external computer. In this sample application, there are hardly any memory and performance limitations.

The sensor recalibration can also be used continuously at the end customer's site or in the field (e.g., smartphone or smartwatch in use) to compensate for sensitivity errors that occur over the operating life due to humidity, temperature, and/or changes in the mechanical load. The sensor recalibration can also be used regularly in the field. Here, an algorithm for deciding whether the sensor recalibration should be terminated in step S2 of the method according to the present invention runs either on an MCU of the sensor or on a host.

Further embodiments are possible. For example, in a possible implementation, it is monitored how often the sensor recalibration is terminated or interrupted due to a fulfilled termination criterion AK. This is counted in a possible implementation. If the interruption occurs too often and/or the micromechanical sensor SEN cannot be recalibrated within a certain time interval, a corresponding warning message can be generated, which is transmitted, for example, to a controller of the device.

In a possible embodiment, the device comprises a user interface. This can be used by a user to edit and adjust termination criteria AK and to logically link them to one another for the application in question. The user interface can also display possible warning messages with regard to an unsuccessful recalibration of a micromechanical sensor SEN installed inside the device.

What is claimed is:

1. A method for monitoring a state of a micromechanical sensor, the micromechanical sensor including a spring-mounted seismic mass, which is provided for converting a physical input variable into an electrical sensor output signal of the micromechanical sensor, the comprising the following steps:
evaluating the sensor output signal of the micromechanical sensor for detecting harmful vibrations, which distort a recalibration of the micromechanical sensor; and
interrupting the recalibration of the micromechanical sensor as soon as a harmful vibration has been detected.

2. The method for monitoring the state of a micromechanical sensor according to claim 1, wherein the sensor output signal of the micromechanical sensor is evaluated to determine whether at least one predefined termination criterion for interrupting the recalibration of the micromechanical sensor is fulfilled.

3. The method for monitoring the state of a micromechanical sensor according to claim 2, wherein the termination criterion for interrupting the recalibration of the micromechanical sensor includes the sensor output signal of the micromechanical sensor exceeding a defined threshold value.

4. The method for monitoring the state of a micromechanical sensor according to claim 1, wherein the sensor output signal of the micromechanical sensor for evaluating the sensor output signal is stored temporarily.

5. The method for monitoring the state of a micromechanical sensor according to claim 1, wherein the micromechanical sensor includes at least one micromechanical gyroscope, which provides an angular velocity signal as a sensor output signal.

6. The method for monitoring the state of a micromechanical sensor according to claim 1, wherein the micromechanical sensor includes at least one micromechanical acceleration sensor, which provides an acceleration signal of a linear acceleration as a sensor output signal.

7. The method for monitoring the state of a micromechanical sensor according to claim 1, wherein the sensor output signal of the micromechanical sensor is subjected to: (i) a drift analysis and/or (ii) a statistical check of average values, standard deviations, minimum and maximum values in order to determine whether at least one predefined termination criterion for interrupting the recalibration of the micromechanical sensor is fulfilled.

8. The method for monitoring the state of a micromechanical sensor according to claim 1, wherein the sensor output signal of the micromechanical sensor is evaluated by fast Fourier transforms or wavelet transforms in order to detect distortions in undesired frequency ranges.

9. The method for monitoring the state of a micromechanical sensor according to claim 1, wherein the recalibration of the micromechanical sensor: (i) is initiated by a start signal actively triggered by a user and/or (ii) is initiated by at least one defined sensor event and/or (iii) is initiated automatically at defined time intervals.

10. The method for monitoring the state of a micromechanical sensor according to claim 1, wherein the recalibration of the micromechanical sensor is initiated after the sensor has been installed in a device.

11. The method for monitoring the state of a micromechanical sensor according to claim 1, wherein the recalibration of the micromechanical sensor is initiated during ongoing sensor operation.

12. The method for monitoring the state of a micromechanical sensor according to claim 1, wherein the sensor output signal of the micromechanical sensor is evaluated both before the sensor recalibration and after the sensor recalibration of the micromechanical sensor for detecting harmful vibrations.

13. The method for monitoring the state of a micromechanical sensor according to claim 12, wherein the recalibration of the micromechanical sensor is performed when the sensor output signal of the micromechanical sensor does not fulfill any defined termination criterion before the sensor recalibration or after the sensor recalibration of the micromechanical sensor.

14. The method for monitoring the state of a micromechanical sensor according to claim 1, wherein the sensor output signal of the micromechanical sensor is evaluated during the sensor recalibration for detecting harmful vibrations.

15. The method for monitoring the state of a micromechanical sensor according to claim 14, wherein the recalibration of the micromechanical sensor is performed when the sensor output signal of the micromechanical sensor does not fulfill any defined termination criterion during the sensor recalibration.

16. A micromechanical sensor, comprising:
a spring-mounted seismic mass for converting a physical input variable into an electrical sensor output signal of the micromechanical sensor; and
a state monitoring unit configured to evaluate the sensor output signal of the micromechanical sensor for detecting harmful vibrations, which distort a recalibration of the micromechanical sensor, and is configured to automatically interrupt the recalibration of the micromechanical sensor as soon as a harmful vibration has been detected.

17. The micromechanical sensor according to claim 16, wherein the micromechanical sensor includes at least one micromechanical gyroscope, which generates an angular velocity signal as a sensor output signal.

18. The micromechanical sensor according to claim 16, wherein the micromechanical sensor includes at least one acceleration sensor, which generates an acceleration measurement signal as a sensor output signal.

19. A device, comprising:
a microelectromechanical sensor, including:
a spring-mounted seismic mass for converting a physical input variable into an electrical sensor output signal of the micromechanical sensor, and
a state monitoring unit configured to evaluate the sensor output signal of the micromechanical sensor for detecting harmful vibrations, which distort a recalibration of the micromechanical sensor, and is configured to automatically interrupt the recalibration of the micromechanical sensor as soon as a harmful vibration has been detected.
